(19) United States
(12) Patent Application Publication
(10) Pub. No.: US 2025/0227597 A1
(43) Pub. Date: Jul. 10, 2025

(54) TERMINAL BEHAVIOR CONTROL FOR NETWORK REGISTRATION

(71) Applicant: Nokia Technologies Oy, Espoo (FI)

(72) Inventors: Sung Hwan WON, Dallas, TX (US); Lazaros GKATZIKIS, Athens (GR); Pallab GUPTA, Bangalore (IN); Alessio CASATI, WEST MOLESEY (GB)

(21) Appl. No.: 18/855,621

(22) PCT Filed: Apr. 11, 2023
(86) PCT No.: PCT/IB2023/053709

§ 371 Date: Oct. 9, 2024

(30) Foreign Application Priority Data
Apr. 12, 2022 (IN) 202241021873

(51) Int. Cl. H04W 40/22; H04W 60/04; H04W 76/10

(52) U.S. Cl. CPC H04W 40/22; H04W 60/04; H04W 76/10

(57) ABSTRACT

Methods, systems, apparatuses, and computer program products are provided for terminal behavior control for network registration in a communication network. In this regard, a user equipment (UE) receives a route selection policy (URSP) sent by a core network. The URSP for the UE includes at least one indication that the UE is to initiate registration to request at least one connectivity parameter for a communication network. Additionally, registration to the communication network is initiated based on the at least one indication to request the at least one connectivity parameter for the communication network.

### RELATED APPLICATIONS

This patent application claims the benefit of priority of Indian Patent Application number 202241021873, filed Apr. 12, 2022, which is hereby incorporated by reference as if reproduced in its entirety.

### TECHNOLOGICAL FIELD

An example embodiment of the present disclosure generally relates to communication systems and, more particularly, to network registration for a communications network.

### BACKGROUND

Fourth generation (4G) wireless mobile telecommunications technology, also known as Long Term Evolution (LTE) technology, was designed to provide high-capacity mobile multimedia with high data rates particularly for human interaction. Next generation or fifth generation (5G) technology is intended to be used not only for human interaction, but also for machine type communications in so-called Internet of Things (IoT) networks.

Third generation partnership project (3GPP) has developed standards for 5G technology, including standards for next generation radio access networks and 5G network architectures that can deliver extreme broadband and ultra-robust, low latency connectivity. 5G technology improves a variety of telecommunication services offered to the end users and helps to support massive broadband that delivers gigabytes of bandwidth per second on demand for both the uplink and downlink transmissions. Next generation networks, which are based on the 5G network architecture, utilize virtualized radio access network (RAN) functions and core network functions.

In a 5G network (e.g., a next generation network which is based on the on the 5G network architecture), network slicing is a concept for running multiple logical networks as independently on a common physical infrastructure. A network slice is considered as an independent virtualized end-to-end network. When a user equipment (UE) attempts to register to a network, the UE requests one or more network slices. However, under current network protocols, a UE can select, in certain instances, a sub-optimal network slice to register to a network.

### BRIEF SUMMARY

Methods, apparatuses and computer program products are provided in accordance with example embodiments to provide for terminal behavior control for network registration in a communication network.

In an example embodiment, a method is provided. The method includes sending, by a core network to a user equipment (UE), a UE route selection policy (URSP) for the UE. The URSP for the UE comprises at least one indication that the UE is to initiate registration to request at least one connectivity parameter for a communication network.

In some embodiments, the method includes configuring the at least one indication as a route selection descriptor (RSD) indication in at least one RSD of a URSP rule of the URSP for the UE. In some embodiments, the method includes configuring the at least one indication as an route selection descriptor (RSD) indication for all RSDs in a URSP rule of the URSP for the UE. In some embodiments, the at least one connectivity parameter comprises a network slice.

In some embodiments, the method includes sending, by the core network, a policy command message to the UE. In some embodiments, the policy command message comprises at least the URSP for the UE comprising the at least one indication. In some embodiments, the URSP for the UE included in the policy command message comprises one or more URSP rules for the UE, the one of the one or more URSP rules comprising the at least one indication.

In some embodiments, the method includes configuring the URSP with the at least one indication in response to receiving a message from the UE.

In some embodiments, the method includes receiving a manage UE policy complete message from the UE. In some embodiments, the manage UE policy complete message comprises an indication of success or failure related to registration of the UE to the communication network.

In some embodiments, the method includes encoding the at least one indication into the URSP for the UE. In some embodiments, the method includes encoding the at least one indication into a least one RSD of a URSP rule of the URSP for the UE.

In some embodiments, the method includes receiving a UE state indication message from the UE. In some embodiments, the UE state indication message comprises at least an feature support indication, the feature support indication indicating that the UE is capable of initiating registration based on the at least one indication.

In some embodiments, the method includes configuring the URSP to include the at least one indication in response to receipt of the UE state indication message.

In another example embodiment, an apparatus includes processing circuitry and at least one memory including computer program code instructions that are configured to, when executed by the processing circuitry, cause the apparatus to send to a UE, a URSP for the UE. The URSP for the UE comprising at least one indication that the UE to initiate registration to request at least one connectivity parameter for a communication network.

In some embodiments, the computer program code instructions are also configured to, when executed by the processing circuitry, cause the apparatus to configure the at least one indication as an RSD indication in a RSD of a URSP rule of the URSP for the UE. In some embodiments, the computer program code instructions are also configured to, when executed by the processing circuitry, cause the apparatus to configure the at least one indication as an route selection descriptor (RSD) indication for all RSDs in a URSP rule of the URSP for the UE. In some embodiments, the connectivity parameter comprises a network slice.

In some embodiments, the computer program code instructions are also configured to, when executed by the processing circuitry, cause the apparatus to send a manage UE policy command message to the UE. In some embodiments, the manage UE policy command message comprises at least the URSP for the UE.

In some embodiments, the computer program code instructions are also configured to, when executed by the processing circuitry, cause the apparatus to send a policy command message to the UE. In some embodiments, the policy command message comprises at least the URSP for the UE comprising the at least one indication. In some embodiments, the URSP for the UE included in the policy command message comprises one or more URSP rules, the one or more URSP rules comprising the at least one indication.

In some embodiments, the computer program code instructions are also configured to, when executed by the processing circuitry, cause the apparatus to configure the URSP with the at least one indication in response to receipt of a message from the UE.

In some embodiments, the computer program code instructions are also configured to, when executed by the processing circuitry, cause the apparatus to receive a manage UE policy complete message from the UE. In some embodiments, the manage UE policy complete message comprises an indication of success or failure related to registration of the UE to the communication network.

In some embodiments, the computer program code instructions are also configured to, when executed by the processing circuitry, cause the apparatus to encode the at least one indication into the URSP for the UE. In some embodiments, the computer program code instructions are also configured to, when executed by the processing circuitry, cause the apparatus to encode the at least one indication into at least one RSD of a URSP rule of the URSP for the UE.

In some embodiments, the computer program code instructions are also configured to, when executed by the processing circuitry, cause the apparatus to receive a UE state indication message from the UE. The UE state indication message comprises at least a feature support indication, the feature support indication indicating that the UE is capable of initiating registration based on the at least one indication. In some embodiments, the computer program code instructions are also configured to, when executed by the processing circuitry, cause the apparatus to configure the URSP to include the at least one indication in response to receipt of the UE state indication message.

In another example embodiment, a computer program product is provided. The computer program product includes at least one non-transitory computer readable storage medium having computer-executable program code instructions stored therein with the computer-executable program code instructions including program code instructions configured, upon execution, to send a URSP for the UE. The URSP for the UE comprises at least one indication that the UE is to initiate registration to request at least one connectivity parameter for a communication network.

In some embodiments, the computer-executable program code instructions are also configured to configure the at least one indication as an RSD indication in at least one RSD of a URSP rule of the URSP for the UE. In some embodiments, the computer-executable program code instructions are also configured to configure the at least one indication as an route selection descriptor (RSD) indication for all RSDs in a URSP rule of the URSP for the UE. In some embodiments, the connectivity parameter comprises a network slice. In some embodiments, the UE initiates registration to register to the network slice.

In some embodiments, the computer-executable program code instructions are also configured to send a policy command message to the UE. In some embodiments, the policy command message comprises at least the URSP for the UE comprising the at least one indication. In some embodiments, the URSP included in the policy command message comprises one or more URSP rules, the one or more URSP rules comprising the at least one indication.

In some embodiments, the computer-executable program code instructions are also configured to configure the URSP with the at least one indication in response to receipt of a message from the UE.

In some embodiments, the computer-executable program code instructions are also configured to receive a manage UE policy complete message from the UE. In some embodiments, the manage UE policy complete message comprises an indication of success or failure related to registration of the UE to the communication network.

In some embodiments, the computer-executable program code instructions are also configured to encode the at least one indication into the URSP for the UE. In some embodiments, the computer-executable program code instructions are also configured to encode the at least one indication into at least one RSD of a URSP rule of the URSP for the UE.

In some embodiments, the computer-executable program code instructions are also configured to receive a UE state indication message from the UE. The UE state indication message comprises at least a feature support indication, the feature support indication indicating that the UE is capable of initiating registration based on the at least one indication. In some embodiments, the computer-executable program code instructions are also configured to configure the URSP for the UE to include the at least one indication in response to receipt of the UE state indication message.

In yet another example embodiment, an apparatus is provided that includes means for sending to a UE, a URSP for the UE. The URSP for the UE comprises at least one indication that causes the UE to initiate registration to request at least one connectivity parameter for a communication network.

In some embodiments, the apparatus of this example embodiment also includes means for configuring the at least one indication as an RSD indication in at least one RSD of a URSP rule of the URSP for the UE. In some embodiments, the apparatus of this example embodiment also includes means for configuring the at least one indication as an route selection descriptor (RSD) indication for all RSDs in a URSP rule of the URSP for the UE. In some embodiments, the connectivity parameter comprises a network slice.

In some embodiments, the apparatus of this example embodiment also includes means for sending to the UE, a policy command message. In some embodiments, the policy command message comprises at least the URSP for the UE comprising the at least one indication. In some embodiments, the URSP for the UE included in the policy command message comprises one or more URSP rules, the one or more URSP rules comprising the at least one indication.

In some embodiments, the apparatus of this example embodiment also includes means for configuring the URSP with the at least one indication in response to receipt of a message from the UE.

In some embodiments, the apparatus of this example embodiment also includes means for receiving a manage UE policy complete message from the UE. In some embodiments, the manage UE policy complete message comprises an indication of success or failure related to registration of the UE to the communication network.

In some embodiments, the apparatus of this example embodiment also includes means for encoding the at least one indication into the URSP for the UE. In some embodiments, the apparatus of this example embodiment also includes means for encoding the at least one indication into at least one RSD of a URSP rule of the URSP for the UE.

In some embodiments, the apparatus of this example embodiment also includes means for receiving a UE state indication message from the UE. In some embodiments, the UE state indication message comprises at least a feature support indication, the feature support indication indicating that the UE is capable of initiating registration based on the at least one indication. In some embodiments, the apparatus of this example embodiment also includes means for configuring the URSP to include the at least one indication in response to receipt of the UE state indication message.

In another example embodiment, a method is provided. The method includes receiving, by a UE, a URSP for the UE sent by a core network. The URSP for the UE comprises an indication that the UE to initiate registration to request at least one connectivity parameter for a communication network. The method also includes initiating registration based on the at least one indication to request the connectivity parameter for the communication network. In some embodiments, initiating registration comprises initiating a registration procedure at the UE to register the UE to the communication network based on the at least one connectivity parameter.

In some embodiments, the connectivity parameter comprises a network slice. In some embodiments, initiating registration comprises initiating a registration procedure at the UE to register the UE to the network slice of the communication network.

In some embodiments, the method includes sending a UE state indication message to a network device of the communication network. In some embodiments, the UE state indication message comprises at least a feature support indication, the feature support indication indicating that the UE is capable of initiating registration based on the at least one indication.

In some embodiments, the URSP for the UE comprises one or more URSP rules comprising the at least one indication for the UE.

In some embodiments, the initiating registration comprises sending, by the UE to the core network, a request for the at least one connectivity parameter for the communication network. In some embodiments, the initiating registration comprises initiating establishment of a protocol data unit (PDU) session. In some embodiments, establishment of a PDU session comprises sending a request to the core network to establish a PDU session.

In some embodiments, the initiating registration comprises initiating registration to the communication network in response to the at least one indication. In some embodiments, the initiating registration to the communication network comprises initiating registration to the communication network upon detecting a request to establish a PDU session establishment for an application associated with the UE.

In some embodiments, in response to a failure related to the initiating registration to the communication network, the method includes initiating another registration to the communication network to the communication network using another matching RSD of the URSP.

In some embodiments, in response to a failure related to the initiating registration to the communication network, the method includes initiating another registration to the communication network using another RSD of the URSP.

In some embodiments, in response to a failure related to the initiating registration to the communication network, the method includes initiating another registration to another communication network supporting the at least one connectivity parameter as indicated by the at least one indication included in the URSP.

In some embodiments, the method includes initiating another registration to the communication network based on priority values assigned to route selection descriptors of a URSP rule of the URSP.

In another example embodiment, an apparatus includes processing circuitry and at least one memory including computer program code instructions that are configured to, when executed by the processing circuitry, cause the apparatus to receive, by a UE, a URSP for the UE sent by a core network. The URSP for the UE comprises at least one indication that the UE is to initiate registration to the communication network to request at least one connectivity parameter for a communication network. The computer program code instructions are also configured to, when executed by the processing circuitry, cause the apparatus to initiate registration to the communication network based on the at least one indication to request the connectivity parameter for the communication network.

In some embodiments, the connectivity parameter comprises a network slice.

In some embodiments, the computer program code instructions are also configured to, when executed by the processing circuitry, cause the apparatus to send a UE state indication message to the core network of the communication network. In some embodiments, the UE state indication message comprises at least a feature support indication for the UE, the feature support indication indicating that the UE is capable of initiating registration based on the at least one indication.

In some embodiments, the URSP comprises one or more URSP rules comprising the at least one indication for the UE.

In some embodiments, the computer program code instructions are also configured to, when executed by the processing circuitry, cause the apparatus to register the UE the communication network using the at least one connectivity parameter.

In some embodiments, the computer program code instructions are also configured to, when executed by the processing circuitry, cause the apparatus to initiate establishment of a protocol data unit (PDU) session.

In some embodiments, the computer program code instructions are also configured to, when executed by the processing circuitry, cause the apparatus to initiate registration to the communication network in response to the at least one indication. In some embodiments, the computer program code instructions are also configured to, when executed by the processing circuitry, cause the apparatus to initiate registration to the communication network upon detecting a request to establish a PDU session for an application associated with the UE.

In some embodiments, in response to a failure related to the initiating registration to the communication network, the computer program code instructions are also configured to, when executed by the processing circuitry, cause the apparatus to initiate another registration to the communication network using another matching RSD of a URSP rule of the URSP.

In some embodiments, in response to a failure related to the initiating registration to the communication network, the computer program code instructions are also configured to, when executed by the processing circuitry, cause the apparatus to initiate another registration to the communication network using another URSP rule of the URSP.

In some embodiments, in response to a failure related to the initiating registration, the computer program code instructions are also configured to, when executed by the processing circuitry, cause the apparatus to initiate another registration to request the at least one connectivity parameter from another network supporting the at least one connectivity parameter.

In some embodiments, the computer program code instructions are also configured to, when executed by the processing circuitry, cause the apparatus to initiate another registration based on priority values assigned to route selection descriptors of a URSP rule of the URSP.

In another example embodiment, a computer program product is provided. The computer program product includes at least one non-transitory computer readable storage medium having computer-executable program code instructions stored therein with the computer-executable program code instructions including program code instructions configured, upon execution, to receive a URSP for the UE sent by a core network. The URSP for the UE comprises at least one indication that causes the UE to initiate registration to request at least one connectivity parameter for a communication network. The computer-executable program code instructions are also configured to initiate registration to the communication network based on the at least one indication to request the at least one connectivity parameter for the communication network.

In some embodiments, the connectivity parameter comprises a network slice.

In some embodiments, the computer-executable program code instructions are also configured to send a UE state indication message to the core network of the communication network. In some embodiments, the UE state indication message comprises at least a feature support indication.

In some embodiments, the URSP for the UE comprises one or more URSP rules comprising the at least one indication for the UE.

In some embodiments, the computer-executable program code instructions are also configured to register the UE to the communication network using the at least one connectivity parameter.

In some embodiments, the computer-executable program code instructions are also configured to initiate establishment of a PDU session.

In some embodiments, the computer-executable program code instructions are also configured to initiate the registration in response to receipt of the at least one indication. In some embodiments, the computer-executable program code instructions are also configured to initiate the registration upon detecting a request to establish a PDU session for an application associated with the UE.

In some embodiments, in response to a failure related to the initiating registration, the computer-executable program code instructions are also configured to initiate another registration to request the at least one connectivity parameter using a RSD as indicated by the at least one indication.

In some embodiments, in response to a failure related to the initiating registration to the communication network, the computer-executable program code instructions are also configured to initiate another registration to the communication network using another rule of the URSP.

In some embodiments, in response to a failure related to the initiating registration to the communication network, the computer-executable program code instructions are also configured to initiate another registration to another communication network supporting the at least one connectivity parameter as indicated by the at least one indication.

In some embodiments, the computer-executable program code instructions are also configured to initiate another registration to the communication network based on priority values assigned to route selection descriptors of a URSP rule of the URSP.

In yet another example embodiment, an apparatus is provided that includes means for receiving a URSP for the UE sent by a core network. The URSP for the UE comprises at least one indication that the UE is to initiate registration to request at least one connectivity parameter for a communication network. The apparatus of this example embodiment also includes means for initiating registration to the communication network based on the at least one indication to request the connectivity parameter for the communication network.

In some embodiments, the connectivity parameter comprises a network slice.

In some embodiments, the apparatus of this example embodiment also includes means for sending a UE state indication message to the core network of the communication network. In some embodiments, the UE state indication message comprises at least a feature support indication, the feature support indication.

In some embodiments, the URSP comprises one or more URSP rules comprising the at least one indication for the UE.

In some embodiments, the means for initiating the registration comprises means for registering the UE to the communication network using the at least one connectivity parameter. In some embodiments, the means for initiating registration comprises means for requesting establishment of a PDU session.

In some embodiments, the means for initiating registration comprises means for initiating registration in response to receipt of the URSP. In some embodiments, the means for initiating registration comprises means for initiating registration to the communication network upon detecting a request to establish a PDU session establishment for an application associated with the UE.

In some embodiments, in response to a failure related to the initiating registration to the communication network, the apparatus of this example embodiment also includes means for initiating another registration to the communication network using a RSD of a matching URSP rule of the URSP.

In some embodiments, in response to a failure related to the initiating registration to the communication network, the apparatus of this example embodiment also includes means for initiating another registration to the communication network using another URSP rule of the URSP comprising the at least one indication.

In some embodiments, in response to a failure related to the initiating registration to the communication network, the apparatus of this example embodiment also includes means for initiating another registration to request the at least one connectivity parameter for the communication network using another network supporting the at least one connectivity parameter.

In some embodiments, the apparatus of this example embodiment also includes means for initiating another registration to the communication network based on priority values assigned to route selection descriptors of a URSP rule of the URSP for the UE.

### BRIEF DESCRIPTION OF THE DRAWINGS

Having thus described certain example embodiments of the invention in general terms, reference will now be made to the accompanying drawings, which are not necessarily drawn to scale, and wherein:

FIG. 1 depicts an example system environment in which implementations in accordance with one or more example embodiments of the present disclosure;

FIG. 2 is a block diagram of an apparatus configured in accordance with one or more example embodiments of the present disclosure;

FIG. 3 illustrates example transmissions between a user equipment (UE) and a network entity or functions of a core network in accordance with one or more example embodiments of the present disclosure;

FIG. 4 illustrates an example UE route selection policy (URSP) rule in accordance with one or more example embodiments of the present disclosure;

FIG. 5 illustrates an example route selection descriptor of the URSP rule shown in FIG. 4 in accordance with one or more example embodiments of the present disclosure;

FIG. 6 illustrates another example URSP rule in accordance with one or more example embodiments of the present disclosure;

FIG. 7 illustrates a flowchart illustrating operations performed, such as by the apparatus of FIG. 2, in order to provide for terminal behavior control for network registration in a communication network, in accordance with one or more example embodiments of the present disclosure;

FIG. 8 illustrates a flowchart illustrating operations performed, such as by the apparatus of FIG. 2, in order to provide for terminal behavior control for network registration via a network device, in accordance with one or more example embodiments of the present disclosure; and

FIG. 9 illustrates a flowchart illustrating operations performed, such as by the apparatus of FIG. 2, in order to provide for terminal behavior control for network registration, in accordance with one or more example embodiments of the present disclosure.

### DETAILED DESCRIPTION

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As defined herein, a “computer-readable storage medium,” which refers to a physical storage medium (e.g., volatile or non-volatile memory device), may be differentiated from a “computer-readable transmission medium,” which refers to an electromagnetic signal.

Third generation partnership project (3GPP) 5^{th} generation (5G) technology is a next generation of radio systems and network architecture that can deliver extreme broadband and ultra-robust, low latency connectivity. 5G technology improves a variety of telecommunication services offered to the end users, and helps to support massive broadband that delivers gigabytes of bandwidth per second on demand for both the uplink and downlink transmissions. Next generation systems, which utilize the 5G architecture, utilize virtualized radio access network (RAN) functions and core network functions.

Embodiments will be illustrated herein in conjunction with example communication systems and associated techniques for terminal behavior control for network registration (e.g., network slice registration) in a communication network. It should be understood, however, that the scope of the claims is not limited to particular types of communication systems and/or processes disclosed. Embodiments can be implemented in a terminal device (e.g., a user equipment) or a network (e.g., a communication network) of a communication system, using alternative processes and operations. For example, although illustrated in the context of wireless cellular systems utilizing 3GPP system elements such as a 3GPP next generation core network, the disclosed embodiments can be adapted in a straightforward manner to a variety of other types of communication systems. Additionally, while the present disclosure may describe the invention in conjunction with a 5G communications system, the invention also applies to and comprises other networks and network technologies, such as 3G, 4G, Long Term Evolution (LTE), 6G, etc. without limitation.

In accordance with illustrative embodiments implemented in a 5G communication system environment, one or more 3GPP technical specifications (TS) and technical reports (TR) provide further explanation of user equipment and core network elements/entities/functions and/or operations performed by the user equipment and the core network elements/entities/functions, e.g., the 3GPP TS 23.501, the 3GPP TS 23.289, and/or the 3GPP TS 24.501. Other 3GPP TS/TR documents provide other conventional details that one of ordinary skill in the art will realize. However, while illustrative embodiments are well-suited for implementation associated with the above-mentioned 3GPP standards for 5G NR, alternative embodiments are not necessarily intended to be limited to any particular standards.

In a communications system, such as a 5G system, network slicing is a concept for running multiple logical networks as virtually independent operations on a common physical infrastructure. A network slice is considered as an independent virtualized end-to-end logical network. A user equipment (UE) may subscribe to one or more network slices of a communication system. The UE subscription can include several network slices in network slice selection assistance information (NSSAI). A network slice may therefore be identified by single network slice selection assistance information (S-NSSAI). For instance, a network slice can be identified by an S-NSSAI and a set of S-NSSAIs is called NSSAI.

When a UE attempts to register to a communication network, the UE requests one or more network slices (e.g., the UE indicates a requested NSSAI) of the communication network. The UE can be configured with one or more S-NSSAIs of the communication network which can be requested. The one or more S-NSSAIs configured in the UE form a configured NSSAI and a configured NSSAI is stored in the UE on a per-network basis. For example, a UE can be provisioned with multiple configured NSSAIs, each of which can be stored in the UE and associated with a different network.

One or more of S-NSSAIs of a configured NSSAI may be marked as default S-NSSAIs. A default S-NSSAI may identify a network slice the UE can or should be using for communications with the communication network if the UE is not requesting any particular network slice (e.g. S-NSSAI) in the requested NSSAI. In current versions of the 3GPP standard, such as those mentioned herein, an instance in which the UE has been configured with a configured NSSAI, these current standards leave the UE totally free to request any of the allowed S-NSSAIs of the configured NSSAI based on local logic. Under current network protocols, there is no control on the behavior according to which the UE requests one or more of the S-NSSAIs of a configured NSSAI. As such, a UE can select, in certain instances, a sub-optimal network slice (e.g., S-NSSAI) to register to the communication network.

Moreover, under current network protocols such as, for example, 3GPP TS 23.289, an initial mission critical service (MCS) UE configuration for a network (e.g., a home public land mobile network (HPLMN) or a visited PLMN (VPLMN)) is provided to a UE. Additionally, at least one S-NSSAI in an initial MC service UE configuration can be marked as a default S-NSSAI. Accordingly, at least one network slice identity (e.g., a S-NSSAI) for a network can be a subset of the configured NSSAI for the communication network. In other words, one or more S-NSSAIs in a configured NSSAI can be marked as default S-NSSAIs. However, current network protocols do not specify how a UE can employ default S-NSSAIs.

In an example scenario, a UE can employ a configured NSSAI (e.g., S-NSSAI 1, S-NSSAI 2) for a network. S-NSSAI 1 can be employed for MC services (e.g., MC push-to-talk) and S-NSSAI 2 can be employed for normal services (e.g., internet or other network services). When the UE registers to the communication network, the UE can include only a S-NSSAI 2 in a requested NSSAI. However, there is currently no means to control the way a UE selects, from a configured NSSAI, the S-NSSAI(s) to be included in a requested NSSAI. After successful registration, the UE can launch an MC application (e.g., MC push-to-talk). Furthermore, the UE can initiate establishment of a protocol data unit (PDU) session associated with the S-NSSAI 2 to serve the data of the MC application. The characteristics of the PDU session to be established (otherwise referred to as PDU session attributes), are determined by URSP rules of the URPR for the UE. Each URSP rule includes a Traffic descriptor (TD) identifying the matching traffic and one or more Route Selection Descriptors, describing the details of the PDU session to be established, e.g., the network slice. As a result, in this example scenario, the data of the MC application is served by a sub-optimal network slice (e.g., S-NSSAI 2). In certain instance, the MC application may even be unable to obtain service (e.g., if a UE route selection policy (URSP) for the UE includes a URSP rule that indicates that the UE would request S-NSSAI 1 for the MC application). This issue can be amplified since the configured NSSAI generally contains up to double the number of S-NSSAIs that can be requested. Additionally, this issue can be further amplified if candidate S-NSSAIs to be requested are retrieved from multiple MCS configurations (e.g., via initial MSC UE configuration for MC services on top of configured NSSAI). In addition to S-NSSAIs, similar issues can also occur with other route selection descriptor (RSD) parameters such as, for example, with respect to a session and service continuity (SSC) mode.

Certain S-NSSAIs that are requested by a UE can contain at least one indication (e.g., at least one indicator) to assist with operator control of UE behavior in registering and/or deregistering with network slices, as well as establishing and releasing PDU sessions in a communication network. However, employing an indication for certain S-NSSAIs does not account for dynamics of applications requesting connectivity as per URSPs. Therefore, in such instances, a communication network cannot handle scenarios with prioritization of slices to be requested (e.g., if more than eight network slices are marked as default). Furthermore, in such instances, a communication network cannot take into account whether the UE will require a particular network slice (e.g., whether the corresponding application is running). Accordingly, with current communication networks, a UE decides with network slices to request.

Additionally, for current communication networks, if a URSP rule that matches an application includes, in the selected RSD, an S-NSSAI and the S-NSSAI is not included in the allowed NSSAI, another RSD will be selected. Additionally, if no other valid RSD exists, a URSP rule matching the application (e.g., a URSP rule whose traffic description matches the application) which has a higher precedence value (e.g., a less-prioritized URSP rule) will be evaluated. As a result, the default URSP rule will likely be employed and it is also likely that the default URSP rule contains a one-size-fits-all S-NSSAI (e.g., an enhanced mobile broadband (eMBB) S-NSSAI) or no S-NSSAI, which results in one or more of the issues discussed above.

As such, described herein are methods, apparatuses, and computer program products for control of terminal (e.g., UE) behavior (otherwise referred to as terminal control behavior) for network registration (e.g., network slice registration) in a communication network to resolve some or all of the described limitations of current communication networks and/or current network protocols. In various embodiments, the control of terminal behavior is specified by a URSP for a UE and/or corresponding handling of requested NSSAIs. For instance, in various embodiments, a URSP rule for an application requiring a specific S-NSSAI can include a specific S-NSSAI associated with an indication that the application is to be executed only by a network slice associated with the specific S-NSSAI. Additionally, if a URSP rule matching the application (e.g., a URSP rule whose traffic description matches an application), includes the indication, and the S-NSSAI associated with the indication is not included in the allowed NSSAI, the UE can initiate registration (i.e., initiate a registration procedure) to request the S-NSSAI from the communication network. The indication can be part of a URSP rule, one or more RSDs of a URSP rule or an RSD parameter.

In various embodiments, URSP can be employed for initiating registration to request at least network slice for the communication network. For example, URSPs can be provided with an indication on whether the S-NSSAI is mandated for an application. If the S-NSSAI is mandated for an application, one or more URSP rules can be provided. The one or more URSP rules can provide guidance as to how the UE should act subsequently. For example, if an S-NSSAI is mandated for an application, the UE can initiate registration to request the S-NSSAI mandated for the application (“mandated S-NSSAI indication”). Additionally, if the request for the S-NSSAI mandated for the application is rejected by the communication network, the UE can attempt to select a different network to request the S-NSSAI mandated for the application. In various embodiments, a priority value for each S-NSSAI can be provided in the URSP rule to guide the UE to select the S-NSSAIs with the highest priority values as the S-NSSAIs for the requested NSSAI. The UE can employ this priority value to determine which network slices to request for a communication network.

In various embodiments, registration can be initiated immediately or at a later time based on usage of an application, for example only if the application requests a network slice. For example, in certain embodiments, the registration can be usage-based and the registration can be initiated upon request of a network slice by the application (e.g., not initiated based on reception of the indication). As such, in certain embodiments, the UE can request the indicated connectivity parameters, including a network slice, during registration with the communication network even if usage of the connectivity parameters (e.g., network slice) is delayed until a request for a network slice is received for the application. Alternatively, in certain embodiments, the registration can be initiated upon receipt of the indication.

In various embodiments, at least one indication on how an RSD must be used (e.g., a mandatory RSD indication) can be employed to enable a core network to dynamically update and/or configure, a URSP, one or more insights for each RSD of a URSP rule. The mandatory RSD indication can be an indication from the core network that the RSD (e.g., the network slice) is really needed and should be requested using a registration procedure if not available. For example, a RSD indication can be employed to indicate existing backwards compatible handling (e.g., the UE may employ an URSP rule with “match-all” traffic descriptor). Additionally, the mandatory RSD indication can be employed to indicate whether the RSD is really mandatory. The mandatory RSD indication can additionally or alternatively be employed to indicate whether the RSD is preferred and/or whether the UE may use the RSD from another non-default URSP rule matching an existing traffic descriptor (TD). The mandatory RSD indication can additionally or alternatively be employed to indicate whether the RSD should cause the UE to initiate registration. In certain embodiments, the mandatory RSD indication can additionally or alternatively be employed to indicate one or more other details and/or communication network options associated with the RSD. In various embodiments, the UE may first indicate whether it supports this advanced RSD indication such that the network can provide RSD indications to facilitate improved registration of the UE to the communication network.

The RSD may also indicate subsequent UE handling of registration. For example, the RSD may indicate subsequent UE handling of registration if, upon evaluation of the URSP rule, the network slice is not available. The UE can attempt to update its registration to the network by requesting the specific network slice. If the mandatory S-NSSAI (i.e., the mandatory S-NSSAI for an application) that is requested by the UE is rejected by the network, the UE may employ another matching RSD and/or another URSP rule. Additionally or alternatively, if the mandatory S-NSSAI that is requested by the UE is rejected by the network, the UE may select a different network which supports the mandatory S-NSSAI. In certain embodiments, to assist the UE in the selection of S-NSSAI to request, the RSD can contain a priority value indicating the importance of the S-NSSAI. The priority value can be employed by the UE to determine which S-NSSAIs to include in the requested NSSAI. For example, the priority value can be employed by the UE to determine which network slices to request given a certain network slice limitation (e.g., a limitation of eight network slices marked as default). In order to ensure backwards compatibility and/or avoid excessive signaling in a communication network, the UE can indicate, at registration with a core network of a communication network, whether the UE supports the mandatory RSD indication and/or one or more other features associated with terminal behavior control for network registration in a communication network. In various embodiments, a Policy Control Function (PCF), which is a network entity or function of the core network, can indicate how the respective RSDs affect the selection of a network slice by the UE.

By providing terminal behavior control for network registration in a communication network, it is possible to tune behavior of the terminal (e.g., UE behavior) in a network, a network slice, and/or a network entity in a manner tailored to a particular network deployment. For example, by providing terminal behavior control for network registration in a communication network, it is possible to establish an optimal mode of operation for the UE. In some embodiments, registration and/or UE configuration update procedures can be optimized for a UE. Additionally, by providing terminal behavior control for network registration of a terminal in a communication network, it is possible to minimize signaling load and/or reduce bandwidth being dedicated to such signaling, registration/deregistration and/or other such activities. Furthermore, by providing terminal behavior control for network registration in a communication network, the terminal (e.g., the UE) can employ a set of network slices more suitable with a behavior supported by the terminal (e.g., UE) and/or the communication network. Accordingly, performance of a UE and/or a communication network can be improved.

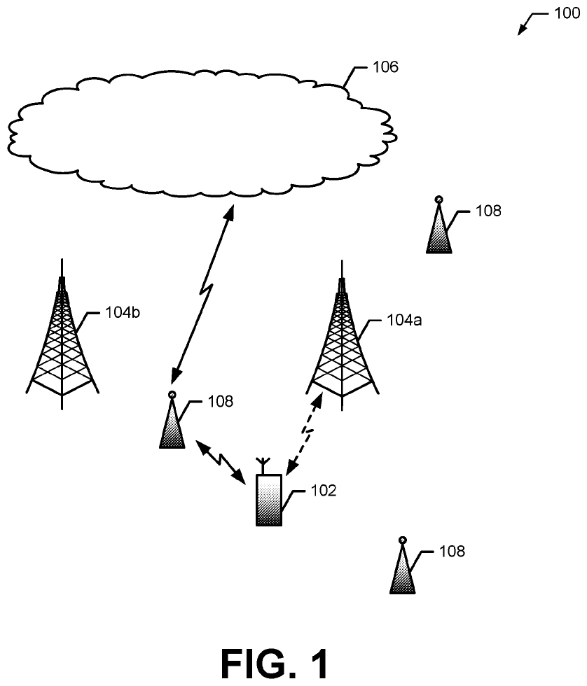

FIG. 1 depicts an example communication system environment 100 in which implementations in accordance with an example embodiment of the present disclosure may be performed. The communication system environment 100 is an environment that includes or corresponds to a communication system. In one or more embodiments, the communication system environment 100 can include one or more terminal devices (e.g., user equipment) and one or more networks (e.g., one or more communication networks). In various embodiments, the communication system environment 100 is an environment that includes or corresponds to a 5G communication system (e.g., a 5G communication network) associated with one or more terminal devices (e.g., user equipment) and/or one or more networks (e.g., one or more communication networks) that support 5G communications. The depiction of the communication system environment 100 (“system environment 100”) in FIG. 1 is not intended to limit or otherwise confine the embodiments described and contemplated herein to any particular configuration of elements or networks, nor is it intended to exclude any alternative configurations or systems for the set of configurations and systems that can be used in connection with embodiments of the present disclosure. Rather, FIG. 1, and the system environment 100 disclosed therein is merely presented to provide an example basis and context for the facilitation of describing some of the features, aspects, and uses of the methods, apparatuses, and computer program products disclosed and contemplated herein. It will be understood that while many of the aspects and components presented in FIG. 1 are shown as discrete, separate elements, other configurations may be used in connection with the methods, apparatuses, and computer programs described herein, including configurations that combine, omit, and/or add aspects and/or components.

In one or more embodiments, the system environment 100 is a network environment. As shown in FIG. 1, the system environment 100 includes one or more user equipment (UE) 102 configured to communicate wirelessly, such as via an access network, with a network 106. Although the user equipment 102 may be configured in a variety of different manners, the user equipment 102 may be embodied as a mobile terminal, such as a portable digital assistant (PDA), mobile phone, smartphone, pager, mobile television, gaming device, laptop computer, camera, tablet computer, communicator, pad, headset, touch surface, video recorder, audio/video player, radio, electronic book, positioning device (e.g., global positioning system (GPS) device), or any combination of the aforementioned, and other types of voice and text and multi-modal communications systems. The system environment 100, as depicted in FIG. 1, also includes one or more access points 104a and 104b, such as one or more base stations, including but not limited to node Bs, evolved Node Bs (eNB), or the like. In some embodiments, the one or more access points 104a and 104b are one or more cellular access points. In some embodiments, the one or more access points 104a and 104b may define and/or service one or more cells. The one or more access points 104a and 104b may, in turn, be in communication with a network 106, such as a core network via a gateway, such that the one or more access points 104a and 104b establish cellular radio access networks by which the user equipment 102 may communicate with the network 106. The system environment 100 of FIG. 1 may include a plurality of different cells and/or networks or parts of such networks including, for example, a 5G radio access network, an LTE (Long-Term Evolution) radio access network, a UMTS (universal mobile telecommunications system) radio access network, etc. In some example implementations, equipment and other infrastructure associated with multiple different cellular radio access networks may be located at or near structures and/or other equipment associated with a particular access point, such as the one or more access points 104a and 104b.

In some implementations of the system environment 100, the cellular radio access networks serviced by the one or more access points 104a and 104b, and any other access points in a given area are identical, in the sense that as the user equipment 102 moves from an area serviced by access point 104a to an area serviced by access point 104b. The user equipment 102 is able to access the network 106 via a radio access network provided across the one or more access points 104a and 104b. Although not shown, the system environment 100 may also include a controller associated with one or more of the access points 104a and 104b, such as, base stations, for example, so as to facilitate operation of the access points 104a and 104b and management of the user equipment 102 in communication therewith. As shown in FIG. 1, the system environment 100 may also include one or more wireless local area networks (WLANs), each of which may be serviced by a WLAN access point 108 configured to establish wireless communications with the user equipment 102. As such, the user equipment 102 may communicate with the network 106 via a WLAN access point as shown in solid lines in FIG. 1, or, alternatively, via an access point (e.g., access point 104a or access point 104b) as shown in dashed lines. The radio access networks as well as the core networks may consist of additional network elements as routers, switches, servers, gateways, and/or controllers.

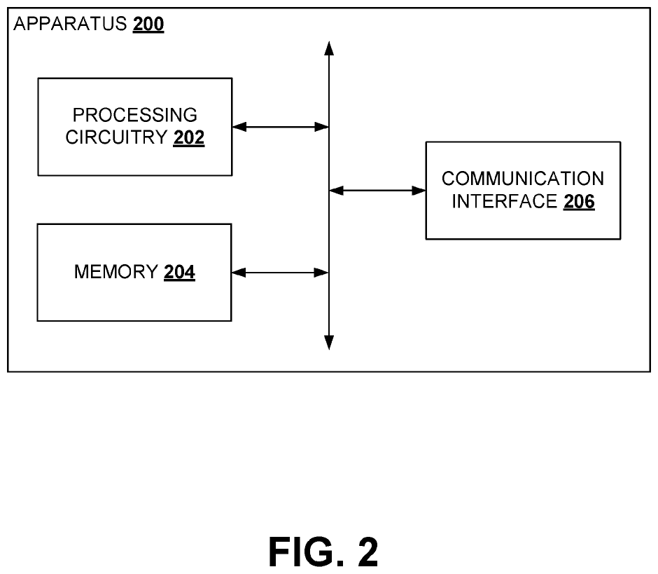

In this regard, the implementation and/or allocation of a network slice within the system environment 100 can be accomplished by an apparatus 200 as depicted in FIG. 2. The apparatus 200 may be embodied by and/or incorporated into one or more UEs, such as user equipment 102, or any of the other devices discussed with respect to FIG. 1, such as access points 104a and/or 104b, one or more of WLAN access points 108, and/or devices that may be incorporated or otherwise associated with system environment 100. Alternatively, the apparatus 200 may be embodied by another device, external to such devices. For example, the apparatus may be embodied by a computing device, such as a personal computer, a computer workstation, a server or the like, or by any of various mobile computing devices, such as a mobile terminal, including but not limited to a smartphone, a tablet computer, or the like, for example.

In some embodiments, the core network of the system environment 100 may include one or more of the following network functions (NF): Authentication Server Function (AUSF), Access and Mobility Management Function (AMF), Data Network (DN), e.g. operator services, Internet access or 3rd party services, Unstructured Data Storage Function (UDSF), Network Exposure Function (NEF), Network Repository Function (NRF), Network Slice Selection Function (NSSF), PCF, Session Management Function (SMF), Unified Data Management (UDM), Unified Data Repository (UDR), User Plane Function (UPF), UE radio Capability Management Function (UCMF), Application Function (AF), User Equipment (UE), Next Generation-Radio Access Network (NG-RAN), 5G-Equipment Identity Register (5G-EIR), Network Data Analytics Function (NWDAF), and Charging Function (CHF). The system environment may further comprise the following network entities: Service Communication Proxy (SCP) and Security Edge Protection Proxy (SEPP).

Regardless of the manner in which the apparatus 200 is embodied, the apparatus 200 of an example embodiment is configured to include or otherwise be in communication with a processing circuitry 202 and a memory 204. In some embodiments, the apparatus 200 is configured to additionally include or otherwise be in communication with a communication interface 206. In some embodiments, the processing circuitry 202 may be in communication with the memory 204 via a bus for passing information among components of the apparatus 200. The memory 204 may be non-transitory and may include, for example, one or more volatile and/or non-volatile memories. In other words, for example, the memory 204 may be an electronic storage device (e.g., a computer readable storage medium) comprising gates configured to store data (e.g., bits) that may be retrievable by a machine (e.g., a computing device like the processing circuitry 202). The memory 204 may be configured to store information, data, content, applications, instructions, or the like for enabling the apparatus 200 to carry out various functions in accordance with an example embodiment of the present disclosure. For example, the memory 204 could be configured to buffer input data for processing by the processing circuitry 202. Additionally or alternatively, the memory 204 could be configured to store instructions for execution by the processing circuitry 202.

As described above, the apparatus 200 may be embodied by a computing device. However, in some embodiments, the apparatus 200 may be embodied as a chip or chip set. In other words, the apparatus 200 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 may therefore, in some cases, be configured to implement an embodiment of the present disclosure on a single chip or as a single “system on a chip.” As such, in some cases, a chip or chipset may constitute means for performing one or more operations for providing the functionalities described herein.

The processing circuitry 202 may be embodied in a number of different ways. For example, the processing circuitry 202 may be embodied as one or more of various hardware processing means including a processor, such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 202 may include one or more processing cores configured to perform independently. A multi-core processor may enable multiprocessing within a single physical package. Additionally or alternatively, the processing circuitry 202 may include one or more processors configured in tandem via the bus to enable independent execution of instructions, pipelining and/or multithreading.

In an example embodiment, the processing circuitry 202 may be configured to execute instructions stored in the memory 204 or otherwise accessible to the processing circuitry 202. Alternatively or additionally, the processing circuitry 202 may be configured to execute hard coded functionality. As such, whether configured by hardware or software methods, or by a combination thereof, the processing circuitry 202 may represent an entity (e.g., physically embodied in circuitry) capable of performing operations according to an embodiment of the present disclosure while configured accordingly. Thus, for example, when the processing circuitry 202 is embodied as an ASIC, FPGA or the like, the processing circuitry 202 may be specifically configured hardware for conducting the operations described herein. Alternatively, as another example, when the processing circuitry 202 is embodied as an executor of software instructions, the instructions may specifically configure the processing circuitry 202 to perform the algorithms and/or operations described herein when the instructions are executed. However, in some cases, the processing circuitry 202 may be a processor of a specific device (e.g., a pass-through display or a mobile terminal) configured to employ an embodiment of the present disclosure by further configuration of the processing circuitry 202 by instructions for performing the algorithms and/or operations described herein. The processing circuitry 202 may include, among other things, a clock, an arithmetic logic unit (ALU) and logic gates configured to support operation of the processing circuitry 202.

The apparatus 200 may optionally include the communication interface 206. The communication interface 206 may be any means such as a device or circuitry embodied in either hardware or a combination of hardware and software that is configured to receive and/or transmit data from/to a network and/or any other device or module in communication with the apparatus. In this regard, the communication interface 206 may include, for example, an antenna (or multiple antennas) and supporting hardware and/or software for enabling communications with a wireless communication network. Additionally or alternatively, the communication interface 206 may include the circuitry for interacting with the antenna(s) to cause transmission of signals via the antenna(s) or to handle receipt of signals received via the antenna(s). In some environments, the communication interface 206 may alternatively or also support wired communication. As such, for example, the communication interface 206 may include a communication modem and/or other hardware/software for supporting communication via cable, digital subscriber line (DSL), universal serial bus (USB) or other mechanisms.

Provided hereinbelow, are example transmissions between a UE 102 and the core network 106 that includes one or more network entities or network functions (e.g., one or more network devices, one or more network components, etc.). The below example transmissions provide the foreseen steps or messaging needed.

In some embodiments, one or more network entities or network functions of a core network can be configured to determine whether a UE supports terminal behavior control for network registration (e.g., network slice registration). Terminal behavior control for network slice registration can be a process that causes registration of the UE 102 to the communication system environment 100 by employing at least one indication from one or more network devices of the communication system environment 100 that the UE 102 is to request at least one connectivity parameter for the communication system environment 100. For example, terminal behavior control for network registration can be a process that causes registration of the UE 102 to a network slice of the communication system environment 100 by employing at least one indication from one or more network devices of the communication system environment 100 that the UE 102 is to request at least one connectivity parameter for the network slice. A connectivity parameter can be associated with an RSD, a data network name (DNN), a network slice, or another connectivity aspect requested by the UE 102. In certain embodiments, the UE 102 can request more than one connectivity parameter for a single network registration. For example, in certain embodiments, the UE 102 can request up to eight connectivity parameters (e.g., up to eight network slices) for a single network registration. In some embodiments, one or more network entities or functions of a core network can be configured to determine whether a UE supports URSP provisioning with a mandatory RSD support indication and/or a mandatory RSD indication. In some embodiments, upon receipt of URSPs, the UE can store the URSPs along with an indication as to whether an RSD is mandatory or not.

In some embodiments, at registration for a network slice, the UE can indicate support for terminal behavior control for network registration by including a mandatory RSD support indication. In some embodiments, if the UE provides the mandatory RSD support indication, a PCF can update one or more URSP rules indicating the needed for handling of certain RSDs. For each parameter (e.g., for each RSD parameter), the PCF can include a mandatory RSD indication. The mandatory RSD indication can be an octet indictor encoded in a defined manner. In some embodiments, the UE can indicate success or failure of an update related to association of an application to a PDU session.

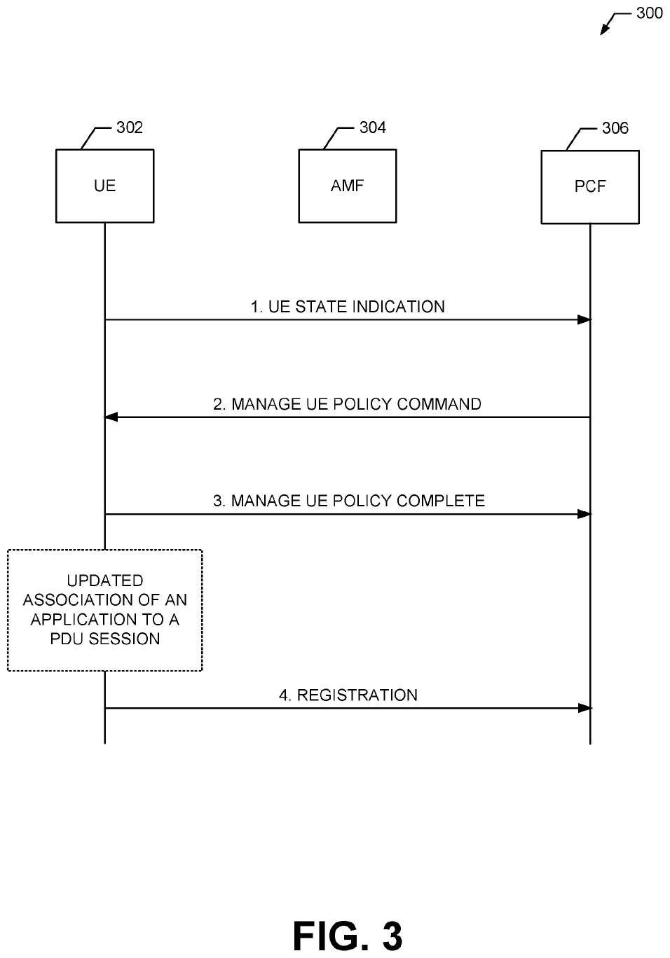

FIG. 3 illustrates example transmissions between a UE 302, an AMF 304, and/or a[DT(-C1] PCF 306 of a communication system for updating the URSPs for the UE 302, and causing a registration according to one or more embodiments. The PCF 306 can be, for example, a network entity or function of a core network of the communication system. In one or more embodiments, the UE 302 can send a message (referred to as UE STATE INDICATION message) to the PCF 306, at 1. In some embodiments, the UE 302 can send the UE STATE INDICATION message to the PCF 306 via the AMF 304. In one or more embodiments, the UE STATE INDICATION message can include a mandatory RSD support indication. The mandatory RSD support indication is a feature support indication that can indicate support for terminal behavior control for initiating registration (e.g., for initiating a registration procedure at the UE 302) to request one or more network connectivity parameters. Additionally or alternatively, the UE STATE INDICATION message can include a UE policy section identifier (UPSI) list, one or more UE policy classmarks, UE identifier information, and/or other information associated with the UE 302. The UPSI list can include a PLMN ID for the PLMN associated with the PCF 306, one or more policies for the UE 302 including the URSP for the UE 302, and/or a UE policy section code (UPSC) that includes a unique value within the PLMN associated with the PCF 306. Additionally, the PCF 306 can receive a URSP for the UE 302 from an external Application Function (AF). In one or more embodiments, the PCF 306 can determine the URSP for the UE 302 based on the UE STATE INDICATION message. In certain embodiments, the mandatory RSD support indication and/or another portion of the UE STATE INDICATION message can provide URSP information related to the URSP for the UE 302. The URSP can include one or more URSP rules for the UE 302.

In response to the mandatory RSD support indication in the UE STATE INDICATION message, the PCF 306, or another suitable network entity of the communication system, can update the one or more URSP rules for the UE 302. The one or more URSP rules of the URSP for the UE 302 which have been updated by the PCF 306 can indicate the needed handling of one or more RSDs. In some embodiments, the one or more URSP rules which have been updated by the PCF 306 can indicate the needed for handling of one or more RSDs associated with the mandatory RSD support indication. For each updated URSP rule and/or associated RSD parameter, the PCF 306 can provide a mandatory RSD indication. An RSD parameter can be with respect to an SSC mode or another mode for the UE 302. In one or more embodiments, the PCF 306 can send a MANAGE UE POLICY COMMAND message to the UE 302, at 2. The MANAGE UE POLICY COMMAND message can be a policy command message for the UE 302. In some embodiments, the PCF 306 can send the MANAGE UE POLICY COMMAND message to the UE 302 via the AMF 304. In one or more embodiments, the MANAGE UE POLICY COMMAND message can include a mandatory RSD indication. For example, the MANAGE UE POLICY COMMAND message can include one or more updated URSPs for the UE and/or one or more updated URSP rules of a URSP for the UE 302. The one or more updated URSPs and/or one or more updated URSP rules of a URSP for the UE 302 can include the mandatory RSD indication. The mandatory RSD indication can be, for example, an indication that causes the UE 302 to initiate registration to request at least one connectivity parameter for the communication network. A connectivity parameter can be a connectivity parameter for one or more network slices, one or more PDU sessions, and/or one or more other aspects of the communication network. Additionally or alternatively, the MANAGE UE POLICY COMMAND message can include a UE policy selection management list. In various embodiments, in response to receiving the MANAGE UE POLICY COMMAND message, the UE 302 can initiate registration to request the at least one connectivity parameter for the communication system (e.g., via one or more network slices, via one or more PDU sessions, via one or more core network, via the AMF 304, etc.) based on the mandatory RSD indication and/or the UE policy selection management list included in the MANAGE UE POLICY COMMAND message.

In one or more embodiments, the UE 302 can send a MANAGE UE POLICY COMPLETE message to the PCF 306, at 3. In some embodiments, the UE 302 can send the MANAGE UE POLICY COMPLETE message to the PCF 306 via the AMF 304. In one or more embodiments, the MANAGE UE POLICY COMPLETE message can include an indication of success or failure related to registration of the UE 302 and may cause a subsequent (re-) registration to the communication network. For example, in one or more embodiments, the MANAGE UE POLICY COMPLETE message can include an indication of success or failure related to registration of the UE 302 to a network slice or establishment of a PDU session for the UE 302. In one or more embodiments, the MANAGE UE POLICY COMPLETE message can include an acknowledgment that the UE 302 is configured to provide an updated associated of an application to a PDU session. For example, the MANAGE UE POLICY COMPLETE message can include an indication of success or failure of an update related to association of an application to a PDU session.

In some embodiments, an RSD can be configured to include a mandatory RSD support indication. For instance, in some embodiments, the mandatory RSD support indication can alternatively be included as part of one or more RSDs within a URSP rule. In some embodiments, each route selection descriptor component can be encoded as a sequence of a one octet route selection descriptor component type identifier, a route selection descriptor component value field, and/or an octet indicating whether the RSD is mandatory. The route selection descriptor component type identifier can be transmitted, for example, prior to the route selection descriptor component value field and/or the octet indicating whether the RSD is mandatory.

In one or more embodiments, based on the mandatory RSD indication included in the MANAGE UE POLICY COMMAND message, the UE 302 can be registered to the communication system (e.g., the AMF 304, the PCF 306, and/or one or more other network devices) via REGISTRATION at 4. For example, based on the mandatory RSD indication included in the MANAGE UE POLICY COMMAND message, the UE 302 can be registered to one or more network slices of the communication system.

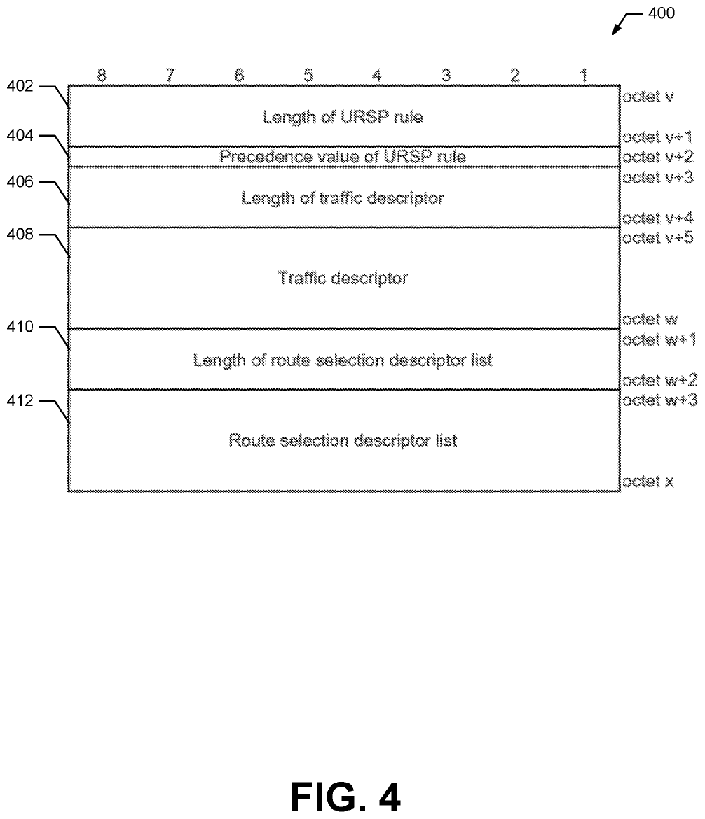

FIG. 4 illustrates an example URSP rule 400, according to one or more embodiments. The URSP rule 400 includes one or more octets encoded in a defined format for the URSP rule 400. For example, the URSP rule 400 can include a first octet range 402 associated with a length of the URSP rule 400, a second octet range 404 associated with a precedence value of the URSP rule 400, a third octet range 406 associated with length of a traffic descriptor, a fourth octet range 408 associated with a traffic descriptor, a fifth octet range 410 associated with a length of a route selection descriptor list, and/or a sixth octet range 412 associated with a route selection descriptor list.

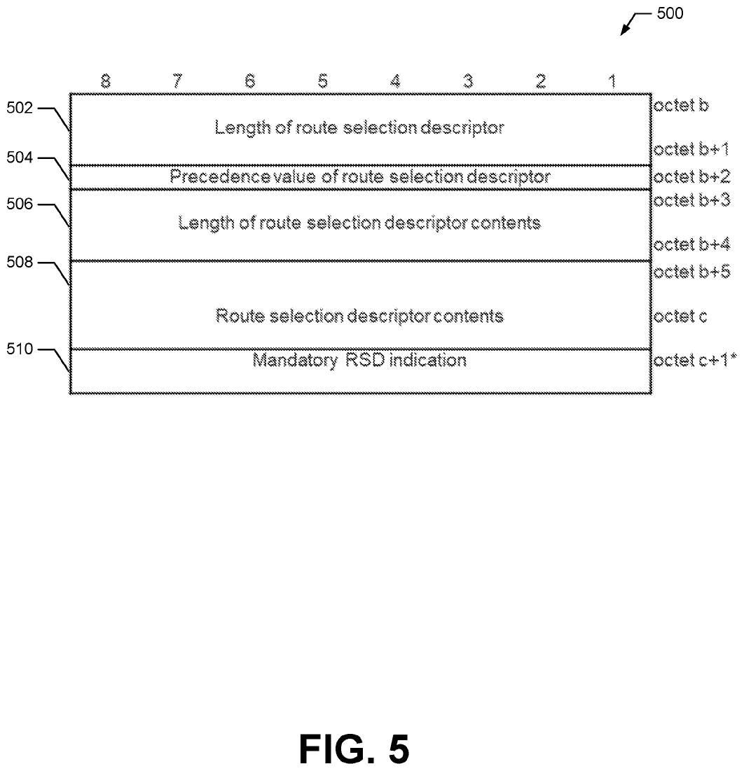

FIG. 5 illustrates an example route selection descriptor 500, according to one or more embodiments. In some embodiments, the route selection descriptor 500 can be a route selection descriptor included in the route selection descriptor list associated with the sixth octet range 412 of the URSP rule 400. The route selection descriptor 500 includes one or more octets encoded in a defined format for the route selection descriptor 500. For example, the route selection descriptor 500 can include a first octet range 502 associated with a length of the route selection descriptor 500, a second octet range 504 associated with a precedence value of the route selection descriptor 500, a third octet range 506 associated with a length of the route selection descriptor contents, a fourth octet range 508 associated with route selection descriptor contents, and/or a fifth octet range 510 associated with a mandatory RSD indication.

In some embodiments, a URSP rule can be configured to include a mandatory RSD support indication. For example, in some embodiments, a mandatory RSD support indication can be included as part of an individual URSP rule. Additionally, the mandatory RSD support indication can be applied to one or more route selection descriptors present in a specific URSP rule.

In some embodiments, each URSP rule can be encoded as a sequence traffic descriptor, a list of route selection descriptors, and/or an octet with the mandatory RSD indication. The mandatory RSD can indicate and/or instruct backwards compatible handling (e.g., that the UE 302 may employ a URSP rule with “match-all” traffic descriptor). The mandatory RSD can additionally or alternatively indicate and/or instruct that an RSD is mandatory (e.g., that an application must employ one of the RSDs in the URSP rule). The mandatory RSD can additionally or alternatively trigger network slice registration if none of the S-NSSAIs in included in an allowed NSSAI list. The mandatory RSD can additionally or alternatively indicate and/or instruct that an RSD is preferred, but that the UE may use another RSD from another non-default URSP rule matching the traffic descriptor. Otherwise, network slice registration can be triggered. The mandatory RSD can additionally or alternatively indicate and/or instruct other information associated with an RSD.

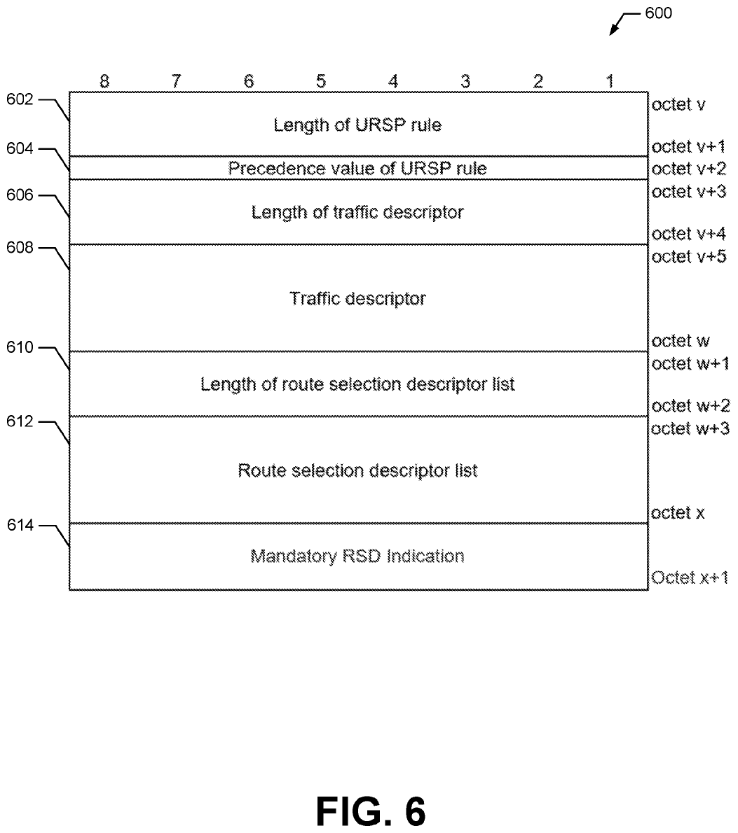

FIG. 6 illustrates an example URSP rule 600, according to one or more embodiments. The URSP rule 600 includes one or more octets encoded in a defined format for the URSP rule 600. For example, the URSP rule 600 can include a first octet range 602 associated with a length of the URSP rule 600, a second octet range 604 associated with a precedence value of the URSP rule 600, a third octet 606 associated with length of a traffic descriptor, a fourth octet 608 associated with a traffic descriptor, a fifth octet 610 associated with a length of a route selection descriptor list, a sixth octet indicator 612 associated with a route selection descriptor list, and/or a seventh octet indicator 614 associated with a mandatory RSD indication.

In some embodiments, the UE 302 can employ an MCS UE configuration. For example, in some embodiments, the UE 302 can be pre-configured with and/or can be provided a MCS UE configuration comprising a S-NSSAI for the MCS. Additionally or alternatively, the UE 302 can provide an indication as to whether the S-NSSAI is a default S-NSSAI or not. In various embodiments, the UE 302 can evaluate the one or more URSP rules updated by the PFC 306. When the UE 302 evaluates the one or more URSP rules, if the RSD of a URSP rule includes an S-NSSAI associated with an indication that the S-NSSAI is a default S-NSSAI, the UE 302 can initiate registration (e.g., initiate a registration procedure) to request the S-NSSAI to the communication network (e.g., if the S-NSSAI is not already included in the allowed NSSAI).

In some embodiments, a special application requests to be executed via a specific network slice. For example, a mission critical push-to-talk (MCPTT) application is generally executed by a public safety network slice (e.g., identified by S-NSSAI X).

In certain embodiments, an S-NSSAI X is not included in an allowed NSSAI for the UE 302. For example, in certain embodiments, the UE 302 does not request a S-NSSAI X during a registration procedure. In another example, a request for a S-NSSAI X may be rejected by a communication network during the registration procedure even though the UE 302 requested the S-NSSAI X. In such an embodiment, even if the UE 302 can identify one or more matching non-default URSP rules (e.g., URSP rules with traffic descriptors that match the MCPTT application), the UE 302 cannot successfully establish a PDU session if the RSDs of the URSP rules include the S-NSSAI X. As such, in certain embodiments, the UE 302 can be configured to initiate registration to request a S-NSSAI X by adding at least one indication in the URSP for the UE that causes the UE to initiate registration to request the S-NSSAI X.

In certain embodiments, a mode for mission critical services (e.g., MC mode operation) can be defined for the UE 302. The UE 302 when configured with the MC mode operation can request one or more default MC S-NSSAIs and/or can be granted authorization for the one or more default MC S-NSSAIs. In certain embodiments, the UE 302 can be determined to be configured with the MC mode operation if Access Identity 2 is determined to be valid for the UE 302 (e.g., as defined in Section 4.5.2 of 3GPP TS 24.501). In other words, the UE 302 can determine whether the UE 302 is to request default S-NSSAI(s) for a communication network based on the validity of access identity for mission critical services in the communication network. In addition, if a communication network indicates that access identity for mission critical services is valid to the UE 302, the communication network can be configured to include default S-NSSAI(s) (e.g., even if the UE 302 did not request the default S-NSSAI(s)) in the allowed NSSAI.

If one or more of the default MC S-NSSAIs are not granted authorization (e.g., even if the one or more of the default MC S-NSSAIs are requested by the UE 302), the UE 302 configured with the MC mode operation can attempt to select a different communication network and/or a different network slice. Alternatively, if the UE 302 cannot identify a communication network and/or a network slice supporting the one or more default MC S-NSSAIs (e.g., by preforming network selection taking into account a rejected NSSAI), the UE 302 can send an indication that the MC mode is not available to the upper layers of protocol stack of the UE 302 and/or the communication network such that a user associated with the UE 302 can be notified that the MC services are not available or that the MC services can be served on a dynamic basis.

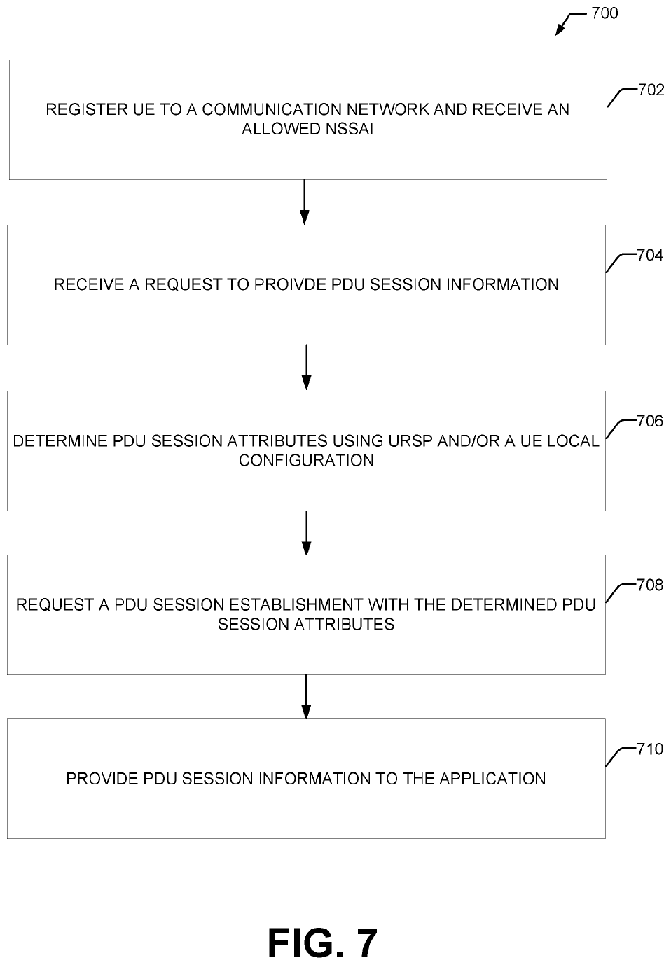

FIG. 7 illustrates a flowchart depicting a method 700 according to an example embodiment of the present disclosure. It will be understood that each block of the flowchart and combination of blocks in the flowchart can be implemented by various means, such as hardware, firmware, processor, circuitry, and/or other communication devices associated with execution of software including one or more computer program instructions. For example, one or more of the procedures described above can be embodied by computer program instructions. In this regard, the computer program instructions which embody the procedures described above can be stored, for example, by the memory 204 of the apparatus 200 employing an embodiment of the present disclosure and executed by the processing circuitry 202. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Referring now to FIG. 7, operations of the method 700 can be performed, by the apparatus 200 of FIG. 2, to provide for terminal behavior control for network registration in a communication network are depicted, in accordance with one or more embodiments of the present disclosure. The apparatus 200 that can perform the operations of the method 700 can be implemented, for example, in the UE 302. As shown in block 702 of FIG. 7, the apparatus 200 includes means, such as the processing circuitry 202, the memory 204, or the like, configured to register the UE 302 to a communication network and to receive an allowed NSSAI. In some embodiments, the memory 204 of the apparatus 200 can store computer program instructions, which when executed by the processing circuitry 202, cause the apparatus 200 to perform the operation depicted in block 702 (i.e., registering the UE 302 to a communication network and to receive an allowed NSSAI). The communication network can be a 5G system or another type of communication network. The UE can be, for example, the UE 302 illustrated in FIG. 3. In some embodiments, during registration, the UE can request several S-NSSAIs for employment by the UE. For example, the UE can send a requested NSSAI to the communication network via a registration request message. In response, the communication network can provide an allowed NSSAI (e.g., a set of S-NSSAIs authorized for employment by the UE) in a registration response message.

As shown in block 704 of FIG. 7, the apparatus 200 also includes means, such as the processing circuitry 202, the memory 204, or the like, configured to receive a request to provide PDU session information. In some embodiments, the memory 204 of the apparatus 200 can store computer program instructions, which when executed by the processing circuitry 202, cause the apparatus 200 to perform the operation depicted in block 704 In some embodiments, after the UE is registered to the communication network, a request to provide PDU session information can be received. The request for the PDU session information can be received in response to launch of an application at the UE. For example, when the application is launched at the UE, an application layer of the UE can request a lower layer of the protocol stack of the UE to provide PDU session information.

As shown in block 706 of FIG. 7, the apparatus 200 also includes means, such as the processing circuitry 202, the memory 204, or the like, configured to determine PDU session attributes using URSP and/or a MRS UE configuration. In some embodiments, the memory 204 of the apparatus 200 can store computer program instructions, which when executed by the processing circuitry 202, cause the apparatus 200 to perform the operation depicted in block 706. In some embodiments, before sending a request to establish a PDU session, the UE determines attributes for the PDU session to be requested. For example, for a PDU session establish request, the UE can specify requested attributes for the PDU session (e.g., S-NSSAI, a data network name, IP multimedia subsystem information, network information, internet information, etc.). The URSP can govern how the UE sets the PDU session attributes in the PDU session establishment request. In various embodiments, a PCF (e.g., the PCF 306) of a core network of the communication newtork can provide the URSP. The URSP can include one or more URSP rules. The respective URSP rules can include a traffic descriptor and/or an RSD. The traffic descriptor can include application information (e.g., an application ID) for the application and the RSD can include one or more PDU session attributes.

As shown in block 708 of FIG. 7, the apparatus 200 also includes means, such as the processing circuitry 202, the memory 204, or the like, configured to request a PDU session establishment with the determined PUD session attributes. In some embodiments, the memory 204 of the apparatus 200 can store computer program instructions, which when executed by the processing circuitry 202, cause the apparatus 200 to perform the operation depicted in block 708. For example, a communication network sublayer of the UE can request the PDU session establishment with the determined PUD session attributes. In some embodiments, the request for the PDU session establishment can be provided using the RSD of the URSP rule with a traffic descriptor that matches the application.

As shown in block 710 of FIG. 7, the apparatus 200 also includes means, such as the processing circuitry 202, the memory 204, or the like, configured to provide PDU session information to the application. In some embodiments, the memory 204 of the apparatus 200 can store computer program instructions, which when executed by the processing circuitry 202, cause the apparatus 200 to perform the operation depicted in block 710. For example, the communication network sublayer of the UE can provide the PDU session information to the application. The PDU session information can include an IP address and/or other PDU session information. In some embodiments, after the PDU session is successfully established, the PUD session information can be provided to one or more upper layers of the UE.

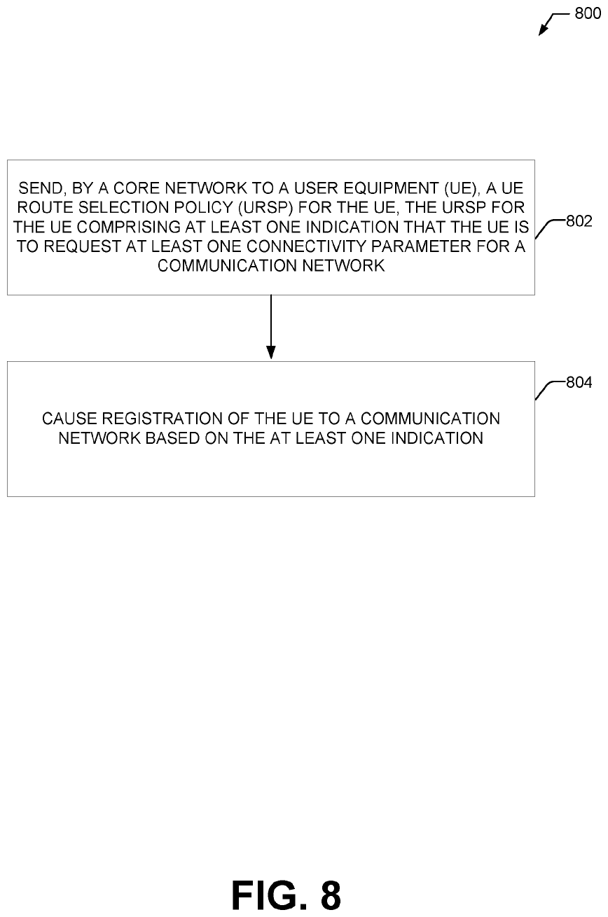

FIG. 8 illustrates a flowchart depicting a method 800 according to an example embodiment of the present disclosure. It will be understood that each block of the flowchart and combination of blocks in the flowchart can be implemented by various means, such as hardware, firmware, processor, circuitry, and/or other communication devices associated with execution of software including one or more computer program instructions. For example, one or more of the procedures described above can be embodied by computer program instructions. In this regard, the computer program instructions which embody the procedures described above can be stored, for example, by the memory 204 of the apparatus 200 employing an embodiment of the present disclosure and executed by the processing circuitry 202. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Referring now to FIG. 8, the operations performed by the apparatus 200 of FIG. 2 when the apparatus 200 of FIG. 2 is part of a core network. The apparatus can implement or include one or more network entities or network functions of the core network, including the AMF 304 and/or the PCF 306 shown in FIG. 3. As shown in block 802 of FIG. 8, the apparatus 200 includes means, such as the processing circuitry 202, the memory 204, or the like, configured to send to a UE, a URSP for the UE, the URSP for the UE comprising at least one indication that causes the UE to initiate registration to request at least one connectivity parameter for a communication network. The at least one indication can be an RSD support indication such as, for example, a mandatory RSD support indication. In some embodiments, the apparatus 200, such as the processing circuitry 202, can be configured to configure the at least one indication as an RSD indication in at least one RSD of a URSP rule of the URSP. In some embodiments, the apparatus 200, such as the processing circuitry 202, can be configured to configure the at least one indication as an route selection descriptor (RSD) indication for all RSDs in a URSP rule of the URSP for the UE. In some embodiments, the connectivity parameter can comprise a network slice. In some embodiments, the connectivity parameter can comprise a network slice parameter for the network slice. In some embodiments, the apparatus 200, such as the processing circuitry 202, can be configured to encode the at least one indication into the URSP for the UE. In some embodiments, the apparatus 200, such as the processing circuitry 202, can be configured to encode the at least one indication into an RSD of a URSP rule of the URSP for the UE.

As shown in block 804 of FIG. 8, the apparatus 200 also includes means, such as the processing circuitry 202, the memory 204, or the like, configured to initiate registration of the UE based on the at least one indication. In some embodiments, the apparatus 200, such as the processing circuitry 202, can be configured to initiate registration of the UE to request a network slice based on the at least one indication. In some embodiments, the apparatus 200, such as the processing circuitry 202, can be configured to initiate establishment of a PDU session based on the at least one indication.

In some embodiments, the apparatus 200, such as the processing circuitry 202, can be configured to send a policy command message to the UE. The policy command message can include at least the URSP for the UE comprising the at least one indication. In some embodiments, the URSP for the UE included in the policy command message can additionally or alternatively include one or more URSP rules comprising the at least one indication.

In some embodiments, the apparatus 200, such as the processing circuitry 202, can be configured to configure the URSP with the at least one indication in response to receipt a message from the UE.

In some embodiments, the apparatus 200, such as the processing circuitry 202, can be configured to receive a UE state indication message from the UE. The UE state indication message can include at least. In some embodiments, the apparatus 200, such as the processing circuitry 202, can be configured to configure the URSP to include the at least one indication in response to receipt of the UE state indication message.

In some embodiments, the apparatus 200, such as the processing circuitry 202, can be configured to send a manage UE policy command message to the UE. The manage UE policy command message can include at least a UE policy section management list for the UE. Furthermore, the UE policy section management list can include the URSP that includes the at least one indication.

In some embodiments, the apparatus 200, such as the processing circuitry 202, can be configured to receive a manage UE policy complete message from the UE. The manage UE policy complete message can include an indication of success or failure related to registration of the UE to the communication network. The indication of success related to the initiating registration of the UE to the communication network can indicate that the UE was successful in registering to the network slice included in the at least one connectivity parameter requested by the UE. The indication of failure related to the initiating registration of the UE to the communication network can indicate that the UE was unsuccessful in registering to the network slice included in the at least one connectivity parameter requested by the UE.

In some embodiments, the apparatus 200, such as the processing circuitry 202, can be configured to receive a UE state indication message from the UE. The UE state indication message can include at least an RSD support indication for a network device. Additionally, in some embodiments, the apparatus 200, such as the processing circuitry 202, can be configured to configure the URSP with the at least one indication in response to the UE state indication message.

In some embodiments, the memory 204 of the apparatus 200 can store computer program instructions, which when executed by the processing circuitry 202, cause the apparatus 200 to perform the operations of the method 800.

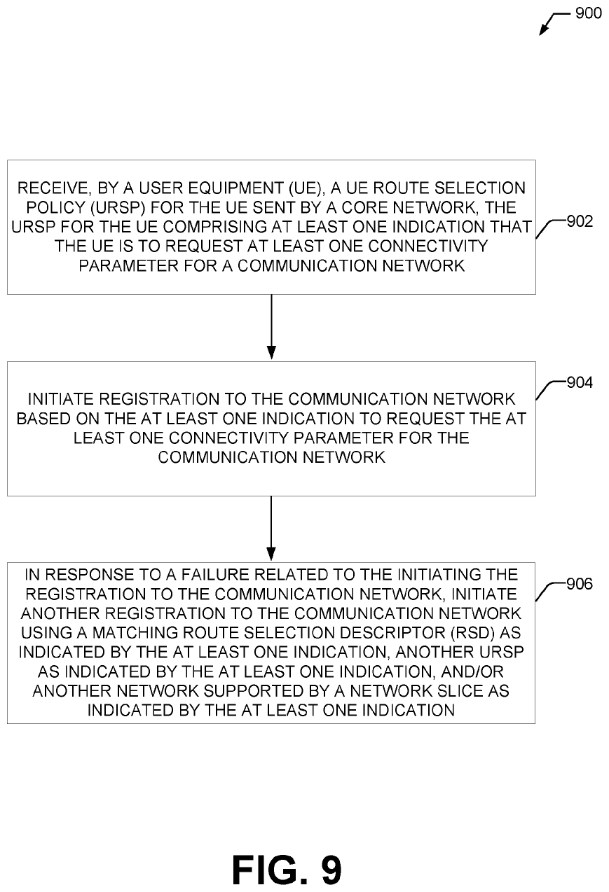

FIG. 9 illustrates a flowchart depicting a method 900 according to an example embodiment of the present disclosure. It will be understood that each block of the flowchart and combination of blocks in the flowchart can be implemented by various means, such as hardware, firmware, processor, circuitry, and/or other communication devices associated with execution of software including one or more computer program instructions. For example, one or more of the procedures described above can be embodied by computer program instructions. In this regard, the computer program instructions which embody the procedures described above can be stored, for example, by the memory 204 of the apparatus 200 employing an embodiment of the present disclosure and executed by the processing circuitry 202. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Referring now to FIG. 9, the operations performed, such as by the apparatus 200 of FIG. 2, in order to provide for terminal behavior control for network registration by a UE are depicted, in accordance with one or more embodiments of the present disclosure. As shown in block 902 of FIG. 9, the apparatus 200 includes means, such as the processing circuitry 202, the memory 204, or the like, configured to receive a URSP for the UE sent by a core network, the URSP for the UE comprising at least one indication that the UE is to request at least one connectivity parameter for a communication network. The at least one indication can be an RSD indication such as, for example, a mandatory RSD indication. In some embodiments, the apparatus 200, such as the processing circuitry 202, can be configured to receive the at least one indication via a manage UE policy command message sent by the core network. In some embodiments, the connectivity parameter can comprise a network slice. In some embodiments, the receiving comprises receiving one or more URSP rules comprising the at least one indication for the UE.

As shown in block 904 of FIG. 9, the apparatus 200 also includes means, such as the processing circuitry 202, the memory 204, or the like, configured to initiate registration based on the at least one indication to request the at least one connectivity parameter for the communication network. In some embodiments, the apparatus 200, such as the processing circuitry 202, can be configured to register the UE to the communication network using the at least one connectivity parameter. In some embodiments, the apparatus 200, such as the processing circuitry 202, can be configured to establish a PDU session based on the at least one indication. In some embodiments, the apparatus 200, such as the processing circuitry 202, can be configured to initiate registration in response to receipt of the at least one indication. In some embodiments, the apparatus 200, such as the processing circuitry 202, can be configured to initiate registration upon detecting a request to establish a PDU session for an application associated with the UE.

As shown in block 906 of FIG. 9, the apparatus 200 also includes means, such as the processing circuitry 202, the memory 204, or the like, configured to, in response to a failure related to the initiating registration to request the at least one connectivity parameter for the communication network, initiate another registration to request the at least one connectivity parameter for the communication network using another matching RSD of the URSP. In some embodiments, the apparatus 200, such as the processing circuitry 202, can be configured to initiate another registration based on respective priority values assigned to RSDs of the URSP.

In some embodiments, the apparatus 200, such as the processing circuitry 202, can be configured to send a UE state indication message to the core network of the communication network. The UE state indication message can include at least a feature support indication for the UE, the feature support indication indicating that the UE is capable of initiating registration based on the at least one indication.

In some embodiments, the apparatus 200, such as the processing circuitry 202, can be configured to send a UE state indication message to a network device of the communication network. The UE state indication message can include at least a RSD support indication for the UE.

In some embodiments, the apparatus 200, such as the processing circuitry 202, can be configured to receive a UE policy section management list. The UE policy section management list can include a URSP for the UE.

In some embodiments, the apparatus 200, such as the processing circuitry 202, can be configured to send a manage UE policy complete message to the core network of the communication network. The manage UE policy complete message can include an indication of success or failure related to the initiating registration of the UE to the communication network. The indication of success related to the initiating registration of the UE to the communication network can indicate that the UE was successful in registering to the network slice included in the at least one connectivity parameter requested by the UE. The indication of failure related to the initiating registration of the UE to the communication network can indicate that the UE was unsuccessful in registering to the network slice included in the at least one connectivity parameter requested by the UE.

In some embodiments, the memory 204 of the apparatus 200 can store computer program instructions, which when executed by the processing circuitry 202, cause the apparatus 200 to perform the operations of the method 900.

As described above, FIGS. 7-9 are flowcharts of various methods that can be carried out by, e.g., the apparatus 200, and/or according to a computer program product, according to example embodiments of the disclosure. A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as, e.g., in conjunction with the communications flowchart of FIG. 3 or as part of the system of FIG. 1. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A user equipment comprising:
at least one processor; and
at least one memory storing instructions which, when executed by the at least one processor, cause the user equipment to perform operations, the operations comprising:
receiving a UE route selection policy (URSP) for the UE from a core network of a communication network, the URSP for the UE comprising an indication that the UE is to initiate registration to the communication network to request at least one connectivity parameter for the communication network; and
initiating registration to the communication network to request the at least one connectivity parameter for the communication network based on the indication.

2. The user equipment of claim 1, wherein the at least connectivity parameter comprises an identifier of a network slice.

3. The user equipment of claim 1, wherein the operations further comprise:
sending a message to the core network of the communication network, wherein the message comprises at least a feature support indication for the UE, a feature support indication indicating that the UE is capable of initiating registration based on the at least one indication.

4. The user equipment of claim 1, wherein the URSP comprises one or more URSP rules comprising the at least one indication for the UE.

5. The user equipment of claim 1, wherein the initiating the registration comprises sending, by the UE to the core network, a request for the at least one connectivity parameter for the communication network.

6. The user equipment of, wherein the initiating the registration to the communication network comprises initiating protocol data (PDU) session establishment to establish a protocol data unit (PDU) session.

7. The user equipment of claim 1, wherein the initiating the registration comprises initiating the registration in response to receipt of the URSP comprising the at least one indication.

8. The user equipment of claim 1, wherein the initiating the registration to the communication network comprises initiating the registration to the communication network upon detecting a request to establish a PDU session for an application associated with the UE.

9. The user equipment of claim 1, wherein the operations further comprise:
in response to a failure related to the initiating the registration to the communication network, initiating another registration to the communication network using a route selection descriptor (RSD) of a matching URSP rule of the URSP for the UE.

10. The user equipment of claim 1, wherein the operations further comprise:
in response to a failure related to the initiating the registration to the communication network, initiating another registration to the communication network using another route selection descriptor (RSD) of URSP for the UE.

11. The user equipment of claim 2, wherein the operations further comprise:
in response to a failure related to the initiating the registration to the communication network, initiating another registration to the communication network using an identifier of another network slice included in the at least one connectivity parameter.

12. The user equipment of claim 1, wherein the operations further comprise:
initiating another registration to the communication network based on priority values assigned to route selection descriptors (RSDs) of a URSP rule of the URSP.

13-15. (canceled)

16. An apparatus for a core network of a communication network, the apparatus comprising:
at least one processor; and
at least one memory storing instructions which, when executed by the at least one processor, cause the user equipment to perform operations, the operations comprising:
sending, to a user equipment (UE), a UE route selection policy (URSP) for the UE, the URSP for the UE comprising an indication that indicates the UE to initiate registration to the communication network to request at least one connectivity parameter for the communication network.

17. The apparatus of claim 16, wherein the operations further comprise:
configuring the indication as a route selection descriptor (RSD) indication in one or more RSDs of a URSP rule of the URSP.

18. The apparatus of claim 16, wherein the operations further comprise:
configuring the indication as a route selection descriptor (RSD) indication in a URSP rule of the URSP.

19. The apparatus of claim 16, wherein the at least one connectivity parameter comprises an identifier of a network slice.

20. The apparatus of claim 16, wherein the operations further comprise:
sending a policy command message to the UE, wherein the policy command message comprises at least the URSP for the UE comprising the indication.

21. The apparatus of claim 20, wherein the URSP included in the policy command message comprises one or more URSP rules comprising the indication.

22. The apparatus of claim 16, wherein the operations further comprise:
configuring the URSP with the indication in response to receipt of a message from the UE.

23. The apparatus of claim 16, wherein the operations further comprise:
receiving a manage UE policy complete message from the UE, wherein the manage UE policy complete message comprises an indication of success or failure related to the registration of the UE to the communication network.

24. The apparatus of claim 16, wherein the operations further comprise:
encoding the indication into the URSP for the UE.

25. The apparatus of claim 16, wherein the operations further comprise:
encoding the indication into a route selection descriptor (RSD) of a URSP rule of the URSP for the UE.

26. The apparatus of claim 16, wherein the operations further comprise:
receiving a UE state indication message from the UE, wherein the UE state indication message comprises at least a feature support indication for the UE, the feature support indication indicating whether the UE is capable of initiating registration based on the indication; and
configuring the URSP to include the indication in response to receipt of the UE state indication message.

27-29. (canceled)
